(19) United States
(12) Patent Application Publication
(10) Pub. No.: US 2018/0157484 A1
(43) Pub. Date: Jun. 7, 2018

(54) FIRMWARE UPDATE METHOD AND SYSTEM

(71) Applicants: INVENTEC (PUDONG) TECHNOLOGY CORP., Shanghai (CN); INVENTEC CORPORATION, Taibei City (TW)

(72) Inventors: Zelong MI, Shanghai (CN); Song ZHANG, Shanghai (CN)

(73) Assignees: INVENTEC (PUDONG) TECHNOLOGY CORP., Shanghai (CN); INVENTEC CORPORATION, Taibei City (TW)

(21) Appl. No.: 15/824,329

(22) Filed: Nov. 28, 2017

(30) Foreign Application Priority Data
Dec. 6, 2016 (CN) 2016111075250

(51) Int. Cl. G06F 9/445; G06F 13/40

(52) U.S. Cl. CPC G06F 8/65; G06F 13/4072; G06F 13/4022; G06F 9/44505

(57) ABSTRACT

A firmware update method and system, includes: a first south bridge chip generating a first update request signal and a first firmware update file; a second south bridge chip generating a second update request signal and a second firmware update file; a controller including a firmware unit, receives the first and second update request signals, judges and generates a control signal; and a switching module switches according to the control signal, selectively conducts with the first or second south bridge chip, receives the first or second firmware update file and sends it to the controller firmware unit for storage. The controller controls the switching module to decide to south bridge chip the current controller is connected, ensures that the controller is connected to only one south bridge chip at a time and merely the firmware update file sent by one south bridge chip is accepted to update the controller firmware.

### TECHNICAL FIELD

The present invention relates to the field of embedded system control, and in particular to a firmware update method and system.

### BACKGROUND

In the past, usually one PCH (integrated south bridge) corresponds to one CPLD and the PCH directly updates the firmware of the CPLD. However, during practical application, two PCHs may share one CPLD and then resource preemption may appear when updating the firmware (FW) of the CPLD or only one PCH can update the FW of the CPLD.

### SUMMARY

In view of the above defects in the prior art, an object of the application is to provide a firmware update method and system to solve the problem in the prior art that when a plurality of PCHs share one CPLD, resource preemption may appear when the PCHs update the firmware of the CPLD.

In order to realize the above object and other objects, the present invention provides a firmware update system. The system includes: a first south bridge chip which generates a first update request signal and a first firmware update file; a second south bridge chip which generates a second update request signal and a second firmware update file; a controller which comprises includes a firmware unit, is electrically connected to the first south bridge chip and the second south bridge chip, receives the first update request signal and the second update request signal and judges and generates a control signal; and a switching module which is electrically connected to the first south bridge chip and the second south bridge chip and electrically connected to the control chip, receives the control signal, selectively conducts with one of the first south bridge chip and the second south bridge chip according to the control signal, receives the one of the first firmware update file and the second firmware update file, and sends same to the firmware unit of the controller for storage to realize the firmware update of the controller.

In a particular embodiment of the application, the firmware update system further includes: a third south bridge chip, which is electrically connected to the controller and the switching module, and generates a third update request signal and a third firmware update file; wherein the controller receives the first update request signal, the second update request signal and the third update request signal, judges and generates the control signal and sends same to the switching module, the switching, selectively conducts with one of the first south bridge chip and the second south bridge chip and the third south bridge chip according to the control signal, receives the one of the first firmware update file and the second firmware update file and the third firmware update file, and sends same to the firmware unit of the controller for storage to realize the firmware update of the controller.

In a particular embodiment of the application, the method for judging and generating the control signal is that the controller, according to the order in which the first update request signal and the second update request signal are received, selects the south bridge chip corresponding to the update request signal received first to conduct with the switching module and generates the control signal.

In a particular embodiment of the application, before the controller receives the first update request signal and the second update request signal, the switching module conducts with one of the first south bridge chip and the second south bridge chip.

In a particular embodiment of the application, the method for judging and generating the control signal is that when the controller receives the first update request signal and the second update request signal simultaneously, the controller generates the control signal and the switching module does not switch according to the control signal.

In a particular embodiment of the application, the switching module selectively conducts with one of the first south bridge chip and the second south bridge chip and the third south bridge chip according to the control signal is, the switching module generates a level signal and sends same to the controller, the controller determines whether the switching of the switching module is successful according to the level signal, and if the switching is successful, the controller sends a switching success signal to the first south bridge chip or the second south bridge chip conducting with the switching module.

In a particular embodiment of the application, if the switching has failed, the controller receives the level signal according to a preset number of polls and determines whether the switching of the switching module is successful according to the level signal, and if the switching is successful, the controller sends the switching success signal to the first south bridge chip or the second south bridge chip conducting with the switching module, and if the switching is still unsuccessful, the controller controls the switching module to exit from switching.

In a particular embodiment of the application, the first update request signal, the second update request signal and the control signal are GPIO signals.

In a particular embodiment of the application, the controller is a complex programmable logic device.

In a particular embodiment of the application, the first south bridge chip and the second south bridge chip are connected to the switching module via a JTAG interface.

In order to realize the above object and other objects, the present invention further provides a firmware update method applied to the communication system mentioned in any of the above. The firmware update method includes: the first south bridge chip generates the first update request signal and sends same to the controller; the second south bridge chip generates the second update request signal and sends same to the controller; the controller judges and generates the control signal according to the received first update request signal and/or the second update request signal and sends the control signal to the switching module; the switching module switches according to the control signal, selectively conducts with one of the first south bridge chip and the second south bridge chip according to the control signal, receives the one of the first firmware update file and the second firmware update file and sends same to the firmware unit of the controller; and the firmware unit of the controller receives and stores the first firmware update file or the second firmware update file to realize the firmware update of the controller.

In a particular embodiment of the application, the method of the switching module, selectively conducting with one of the first south bridge chip and the second south bridge chip according to the control signal is, the switching module generates a level signal and sends same to the controller, the controller determines whether the switching of the switching module is successful according to the level signal, and if the switching is successful, the controller sends a switching success signal to the first south bridge chip or the second south bridge chip conducting with the switching module.

In a particular embodiment of the application, the method further includes: configuring a first request signal sending pin and a first switching success signal receiving pin for the first south bridge chip, configuring a second request signal sending pin and a second switching success signal receiving pin for the second south bridge chip; the first south bridge chip sends the first update request signal to the controller by pulling low the first request signal sending pin and the second south bridge chip sends the second update request signal to the controller by pulling low the second request signal sending pin; the first south bridge chip detects the level state of the first switching success signal receiving pin with a preset time period and, if the level state of the first switching success signal receiving pin is low, determines that the first switching success signal receiving pin has received the switching success signal, and the first south bridge chip sends the first firmware update file to the controller to update the firmware unit of the controller; the second south bridge chip detects the level state of the second switching success signal receiving pin with a preset time period and, if the level state of the second switching success signal receiving pin is low, determines that the second switching success signal receiving pin has received the switching success signal, and the second south bridge chip sends the second firmware update file to the controller to update the firmware unit of the controller

### BRIEF DESCRIPTION OF THE DRAWINGS

FIG. 1 is a composition diagram of a firmware update system according to a particular embodiment of the application.

FIG. 2 is an application structure diagram of a firmware update system according to a particular embodiment of the application.

FIG. 3 is an application structure diagram of a firmware update system according to a particular embodiment of the application.

FIG. 4 is a flow diagram of a firmware update method according to a particular embodiment of the application.

### DESCRIPTION OF REFERENCE NUMERALS

100 Firmware update system
110 First south bridge chip
111 Second south bridge chip
120 Controller
130 Switching module
200 Firmware update system
210 First south bridge chip
211 Second south bridge chip
220 CPLD
230 Switching module
300 Firmware update system
310 First south bridge chip
311 Second south bridge chip
312 Third south bridge chip
320 CPLD
330 Switching module
400 Firmware update method
401˜404 Steps of method

### DETAILED DESCRIPTION

The embodiments of the application will be described by way of specific embodiments. Those skilled in the art may readily understand other advantages and effects of the application from the disclosure of the application. The present invention may also be implemented or applied with other different particular embodiments. Various details in the description may also be modified or varied without departing from the spirit of the application based on different viewpoints and applications. It should be noted that the following embodiments and the features in the embodiments may be combined with each other.

It should be noted that the figures provided in the following embodiments merely illustrate the basic concept of the application in an illustrative manner and the figures merely show components involved in the present invention and are not drawn according to the number, shape and size of components during practical application. The models, number and proportion of various components may be varied during practical application and the layout model of the components may also be more complex.

FIG. 1 is a composition diagram of a firmware update system according to a particular embodiment of the application. The firmware update system 100 comprises a first south bridge chip 110, a second south bridge chip 111, a controller 120 and a switching module 130.

The first south bridge chip 110 generates a first update request signal and a first firmware update file. The second south bridge chip 111 generates a second update request signal and a second firmware update file.

The controller 120 comprises a firmware unit, is electrically connected to the first south bridge chip 110 and the second south bridge chip 111, receives the first update request signal and the second update request signal and judges and generates a control signal.

The switching module 130 is electrically connected to the first south bridge chip 110 and the second south bridge chip 111 and electrically connected to the controller 120, receives the control signal, selectively conducts with one of the first south bridge chip 110 and the second south bridge chip 111 according to the control signal, followed by receiving the one of the first firmware update file and the second firmware update file, and sending same to the firmware unit of the controller 120 for storage to realize the firmware update of the controller 120.

Preferably, the method for judging and generating the control signal is that the controller 120, according to the order in which the first update request signal and the second update request signal are received, selects the south bridge chip corresponding to the update request signal received first to conduct with the switching module and generates the control signal.

In a particular embodiment of the application, before the controller 120 receives the first update request signal and the second update request signal, the switching module 130 conducts with one of the first south bridge chip 110 and the second south bridge chip 111. For example, the controller 120 communicates with the first south bridge chip 110 in default and the switches 130 switches if the controller receives the second update request signal at this moment so that the controller 120 conducts with the second south bridge chip 111.

In a particular embodiment of the application, the method for judging and generating the control signal is that when the controller 120 receives the first update request signal and the second update request signal simultaneously, the controller 120 generates the control signal and the switching module 130 does not switch according to the control signal. That is, at this moment, the controller 120 is not connected to any south bridge chip or maintains the connection to one south bridge chip.

In a particular embodiment of the application, the switching module selectively conducts with one of the first south bridge chip and the second south bridge chip and the third south bridge chip according to the control signal is, the switching module 130 generates a level signal and sends same to the controller 120, the controller 120 determines whether the switching of the switching module 130 is successful according to the level signal, and if the switching is successful, the controller 120 sends a switching success signal to the first south bridge chip 110 or the second south bridge chip 111 conducting with the switching module 130.

In a particular embodiment of the application, if the switching has failed, the controller 120 receives the level signal according to a preset number of polls and determines whether the switching of the switching module 130 is successful according to the level signal, and if the switching is successful, the controller 120 sends the switching success signal to the first south bridge chip 110 or the second south bridge chip 111 conducting with the switching module 130, and if the switching is still unsuccessful, the controller 120 controls the switching module 130 to exit from switching. An upper limit of the number of judgments is set for switching success and if the results obtained after a preset number of judgments are all unsuccessful switching, the switching operation is exited, i.e., the system is prevented from being always in a dead loop of switching judgment, which increases the running efficiency and stability of the system.

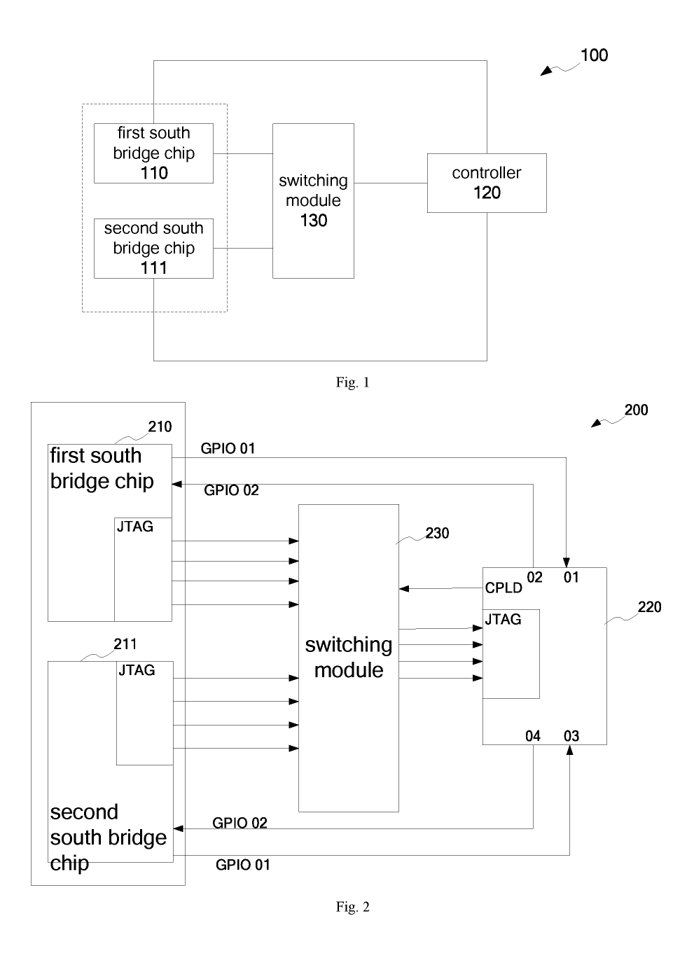

FIG. 2 is an application structure diagram of a firmware update system according to a particular embodiment of the application.

This embodiment is shown in FIG. 1, which is a particular application diagram of the firmware update system 10. The firmware update system 200 includes a first south bridge chip 210, a second south bridge chip 211, a CPLD 220 and a switching module 230.

Preferably, in this embodiment, the first update request signal, the second update request signal and the control signal are GPIO signals. Preferably, the controller 120 is a complex programmable logic device (CPLD). Preferably, the first south bridge chip 210 and the second south bridge chip 211 are connected to the switching module 230 via a JTAG interface. Each south bridge chip configures GPIO01 and GPIO02 to communicate with the CPLD 220, the first south bridge chip 210 sends the first update request signal via the GPIO01, the second south bridge chip 211 sends the second update request signal via the GPIO01, the first south bridge 210 receives a switching success signal fed back by the CPLD 220 via the GPIO02, the second south bridge chip 211 receives a switching success signal fed back by the CPLD 220 via the GPIO02, and the switching module 230 receives the first firmware update file sent by the first south bridge chip 210 via the JTAG interface and sends the first firmware update file to the CPLD 220 via the JTAG interface to update the firmware of the CPLD 220. The switching module 230 receives the second firmware update file sent by the second south bridge chip 211 via the JTAG interface and sends the second firmware update file to the CPLD 220 via the JTAG interface to update the firmware of the CPLD 220.

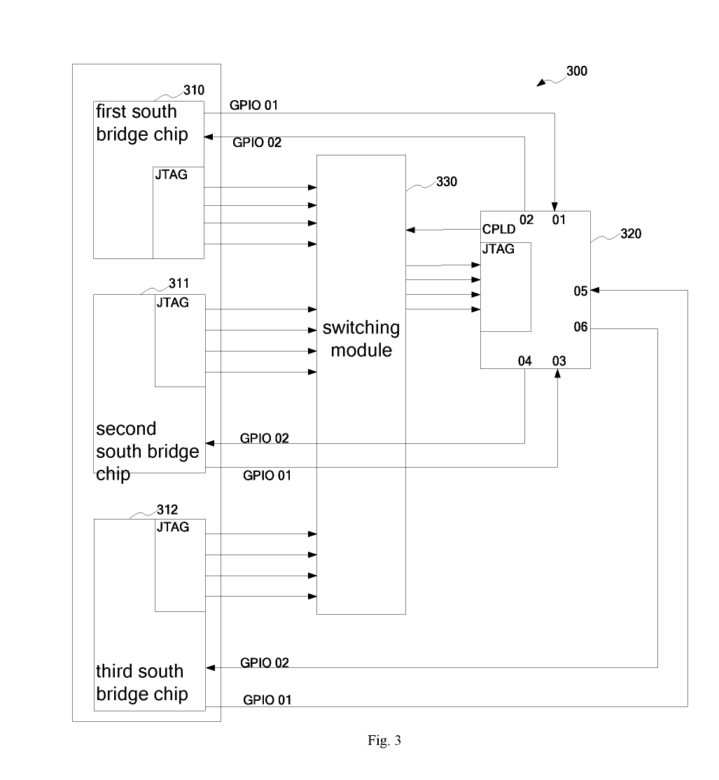

FIG. 3 is an application structure diagram of a firmware update system according to a particular embodiment of the application. Compared to the firmware update system 200 shown in FIG. 2, the firmware update system 300 shown in FIG. 3 adds a third south bridge chip 312. In particular, the firmware update system 300 includes a first south bridge chip 310, a second south bridge chip 311, a third south bridge chip 312, a CPLD 320 and a switching module 330.

Preferably, the third south bridge chip 312 is electrically connected to the CPLD 320 and the switching module 330, generates a third update request signal and a third firmware update file; the CPLD 320 receives the first update request signal, the second update request signal and the third update request signal, judges and generates the control signal and sends same to the switching module 330, the switching module 330 switches according to the control signal, selectively conducts with the first south bridge chip 310 or the second south bridge chip 311 or the third south bridge chip 312, receives the first firmware update file or the second firmware update file or the third firmware update file and sends same to the firmware unit of the CPLD 320 for storage to realize the firmware update of the controller.

Preferably, in this embodiment, the first update request signal, the second update request signal, the third update request signal and the control signal are GPIO signals. Preferably, the first south bridge chip 310, the second south bridge chip 312 and the third south bridge chip 312 are connected to the switching module 330 via a JTAG interface. Each south bridge chip configures GPIO01 and GPIO02 to communicate with the CPLD 320, the first south bridge chip 310 sends the first update request signal via the GPIO01, the second south bridge chip 311 sends the second update request signal via the GPIO01, the third south bridge chip 312 sends the third update request signal via the GPIO01, the first south bridge 310 receives a switching success signal fed back by the CPLD 320 via the GPIO02, the second south bridge chip 311 receives a switching success signal fed back by the CPLD 320 via the GPIO02, the third south bridge chip 312 receives a switching success signal fed back by the CPLD 320 via the GPIO02, and the switching module 330 receives the first firmware update file sent by the first south bridge chip 310 via the JTAG interface and sends the first firmware update file to the CPLD 320 via the JTAG interface to update the firmware of the CPLD 320. The switching module 330 receives the second firmware update file sent by the second south bridge chip 311 via the JTAG interface and sends the second firmware update file to the CPLD 320 via the JTAG interface to update the firmware of the CPLD 320. The switching module 330 receives the third firmware update file sent by the third south bridge chip 312 via the JTAG interface and sends the third firmware update file to the CPLD 320 via the JTAG interface to update the firmware of the CPLD 320.

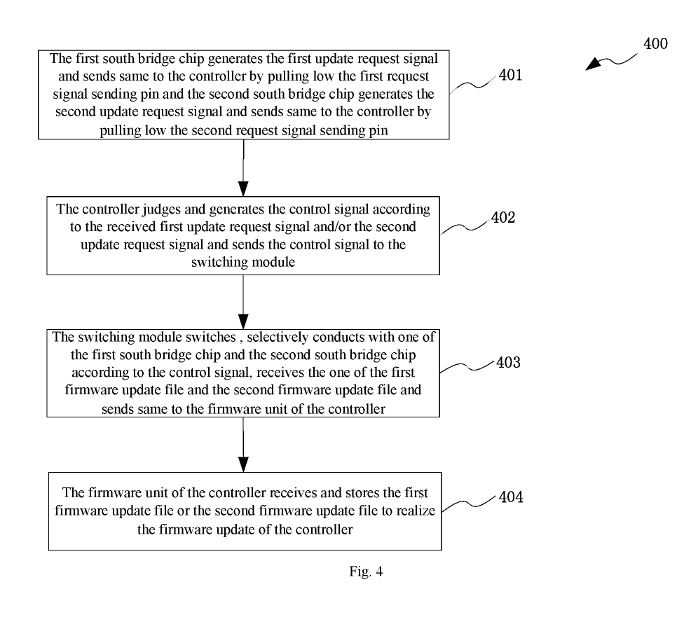

FIG. 4 is a flow diagram of a firmware update method according to a particular embodiment of the application. The firmware update method 400 is applied to the communication system 100 shown in FIG. 1. The firmware update method 400 includes:

401, the first south bridge chip 110 generates the first update request signal and sends same to the controller 120; the second south bridge chip 111 generates the second update request signal and sends same to the controller 120;

402: the controller 120 judges and generates the control signal according to the received first update request signal and/or the second update request signal and sends the control signal to the switching module 130;

403: the switching module 130 switches, selectively conducts with the first south bridge chip 110 or the second south bridge chip 111 according to the control signal, followed by receiving the one of the first firmware update file or the second firmware update file and sending same to the firmware unit of the controller 120; and

404: the firmware unit of the controller 120 receives and stores the first firmware update file or the second firmware update file to realize the firmware update of the controller 120.

In a particular embodiment of the application, the switching module selectively conducts with one of the first south bridge chip and the second south bridge chip and the third south bridge chip according to the control signal is, the switching module 130 generates a level signal and sends same to the controller 120, the controller 120 determines whether the switching of the switching module 130 is successful according to the level signal, and if the switching is successful, the controller 120 sends a switching success signal to the first south bridge chip 110 or the second south bridge chip 111 conducting with the switching module 130.

The method 400 further includes:

configuring a first request signal sending pin and a first switching success signal receiving pin for the first south bridge chip 110 and configuring a second request signal sending pin and a second switching success signal receiving pin for the second south bridge chip 111;

the first south bridge chip 110 sends the first update request signal to the controller 120 by pulling low the first request signal sending pin and the second south bridge chip 111 sends the second update request signal to the controller 120 by pulling low the second request signal sending pin; and

the first south bridge chip 110 detects the level state of the first switching success signal receiving pin with a preset time period and, if the level state of the first switching success signal receiving pin is low, determines that the first switching success signal receiving pin has received the switching success signal, and the first south bridge chip 110 sends the first firmware update file to the controller 120 to update the firmware unit of the controller 120; and the second south bridge chip 111 detects the level state of the second switching success signal receiving pin with a preset time period and, if the level state of the second switching success signal receiving pin is low, determines that the second switching success signal receiving pin has received the switching success signal, and the second south bridge chip 111 sends the second firmware update file to the controller 120 to update the firmware unit of the controller 120.

As mentioned above, the present invention provides a firmware update method and system. The system includes: a first south bridge chip which generates a first update request signal and a first firmware update file; a second south bridge chip which generates a second update request signal and a second firmware update file; a controller which includes a firmware unit, is electrically connected to the first south bridge chip and the second south bridge chip, receives the first update request signal and the second update request signal and judges and generates a control signal; and a switching module which is electrically connected to the first south bridge chip and the second south bridge chip and electrically connected to the control chip, receives the control signal, switches according to the control signal, selectively conducts with the first south bridge chip or the second south bridge chip, receives the first firmware update file or the second firmware update file and sends same to the firmware unit of the controller for storage to realize the firmware update of the controller. In the present invention, the switching module is provided and the controller controls the switching module to decide to which south bridge chip the current controller is connected, which ensures that the controller is connected to only one south bridge chip at the same moment and merely the firmware update file sent by one south bridge chip is accepted to update the firmware of the controller. The present invention can also avoid the situation where a plurality of PCHs write to a CPLD simultaneously and increase the stability of the entire system. Therefore, the present invention effectively overcomes the defects in the prior art and has high industry values.

The above embodiments merely illustrate the principles and effects of the application rather than limiting the present invention. Any person skilled in the art may modify or vary the above embodiments without departing from the spirit and scope of the application. Therefore, any equivalent modifications or variations made by those skilled in the art without departing from the spirit and technical concept of the application shall be covered by the claims of the application.

1. A firmware update system, comprising:
a first south bridge chip, which generates a first update request signal and a first firmware update file;
a second south bridge chip, which generates a second update request signal and a second firmware update file;
a controller, which comprises a firmware unit, is electrically connected to the first south bridge chip and the second south bridge chip, receives the first update request signal and the second update request signal and, judges and generates a control signal; and
a switching module, which is electrically connected to the first south bridge chip and the second south bridge chip, and electrically connected to the controller, receives the control signal, selectively conducts with one of the first south bridge chip and the second south bridge chip according to the control signal, receives the one of the first firmware update file and the second firmware update file, and sends same to the firmware unit of the controller for storage to realize the firmware update of the controller.

2. The firmware update system of claim 1, further comprising: a third south bridge chip, which is electrically connected to the controller and the switching module, and generates a third update request signal and a third firmware update file; wherein the controller receives the first update request signal, the second update request signal and the third update request signal, judges and generates the control signal and sends same to the switching module, the switching module selectively conducts with one of the first south bridge chip and the second south bridge chip and the third south bridge chip according to the control signal, receives the one of the first firmware update file and the second firmware update file and the third firmware update file, and sends same to the firmware unit of the controller for storage to realize the firmware update of the controller.

3. The firmware update system of claim 1, wherein the method for judging and generating the control signal is that the controller, according to the order in which the first update request signal and the second update request signal are received, selects the south bridge chip corresponding to the update request signal received first to conduct with the switching module and generates the control signal.

4. The firmware update system of claim 1, wherein before the controller receives the first update request signal and the second update request signal, the switching module conducts with one of the first south bridge chip and the second south bridge chip.

5. The firmware update system of claim 4, wherein the method for judging and generating the control signal is that when the controller receives the first update request signal and the second update request signal simultaneously, the controller judges and generates the control signal and the switching module does not switch according to the control signal.

6. The firmware update system of claim 1, wherein the switching module selectively conducts with one of the first south bridge chip and the second south bridge chip and the third south bridge chip according to the control signal is, the switching module generates a level signal and sends same to the controller, the controller determines whether the switching of the switching module is successful according to the level signal, and if the switching is successful, the controller sends a switching success signal to the first south bridge chip or the second south bridge chip conducting with the switching module.

7. The firmware update system of claim 6, wherein if the switching has failed, the controller receives the level signal according to a preset number of polls and determines whether the switching of the switching module is successful according to the level signal, and if the switching is successful, the controller sends the switching success signal to the first south bridge chip or the second south bridge chip conducting with the switching module, and if the switching is still unsuccessful, the controller controls the switching module to exit from switching.

8. The firmware update system of claim 1, wherein the first update request signal, the second update request signal and the control signal are GPIO signals.

9. The firmware update system of claim 1, wherein the controller is a complex programmable logic device.

10. The firmware update system of claim 1, wherein the first south bridge chip and the second south bridge chip are connected to the switching module via a JTAG interface.

11. A firmware update method, applied to the communication system of claim 1, comprising:
the first south bridge chip, generating the first update request signal and sending same to the controller;
the second south bridge chip, generating the second update request signal and sending same to the controller;
the controller, judging and generating the control signal, according to the received first update request signal and/or the second update request signal and sending the control signal to the switching module;
the switching module, selectively conducting with one of the first south bridge chip or the second south bridge chip according to the control signal, receiving the one of the first firmware update file or the second firmware update file and sending same to the firmware unit of the controller; and
the firmware unit of the controller receiving and storing the first firmware update file or the second firmware update file to realize the firmware update of the controller.

12. The firmware update method of claim 11, wherein the method of the switching module, selectively conducting with one of the first south bridge chip and the second south bridge chip according to the control signal is, the switching module generates a level signal and sends same to the controller, the controller determines whether the switching of the switching module is successful according to the level signal, and if the switching is successful, the controller sends a switching success signal to the first south bridge chip or the second south bridge chip conducting with the switching module.

13. The firmware update method of claim 12, further comprising:
configuring a first request signal sending pin and a first switching success signal receiving pin for the first south bridge chip and configuring a second request signal sending pin and a second switching success signal receiving pin for the second south bridge chip;
sending the first update request signal to the controller by the first south bridge chip by pulling low the first request signal sending pin and sending the second update request signal to the controller by the second south bridge chip by pulling low the second request signal sending pin; and
detecting the level state of the first switching success signal receiving pin with a preset time period by the first south bridge chip, determining that the first switching success signal receiving pin has received the switching success signal, and sending the first firmware update file to the controller by the first south bridge chip to update the firmware unit of the controller if the level state of the first switching success signal receiving pin is low; detecting the level state of the second switching success signal receiving pin with a preset time period by the second south bridge chip, determining that the second switching success signal receiving pin has received the switching success signal, and sending the second firmware update file to the controller by the second south bridge chip to update the firmware unit of the controller if the level state of the second switching success signal receiving pin is low.
